(19) United States
(12) Patent Application Publication
(10) Pub. No.: US 2026/0117980 A1
(43) Pub. Date: Apr. 30, 2026

(54) GAS TURBINE ENGINE WITH FUEL DISTRIBUTING COMPRESSOR IMPELLER

(71) Applicant: PRATT & WHITNEY CANADA CORP., Longueuil (CA)

(72) Inventors: David MENHEERE, Norval (CA); Eduardo HAWIE, Woodbridge (CA); Daniel VAN DEN ENDE, Mississauga (CA)

(21) Appl. No.: 18/939,713

(22) Filed: Nov. 7, 2024

Related U.S. Application Data
(60) Provisional application No. 63/713,858, filed on Oct. 30, 2024.

(51) Int. Cl. F23R 3/38; F04D 17/10; F04D 29/28

(52) U.S. Cl. CPC F23R 3/38; F04D 17/10; F04D 29/284; F05D 2220/323; F05D 2240/30; F05D 2240/36

(57) ABSTRACT

A gas turbine engine includes a centrifugal compressor having an impeller and a fuel distributor on a rear face of the impeller. The fuel distributor includes a flange defining a fuel plenum on a radially inner side of the flange, and fuel apertures extending radially through the flange of the fuel distributor. The flange is structure such that rotation of the impeller while the gas turbine engine is operating forces fuel in the fuel plenum to flow radially outward through the fuel apertures to generate a spray of atomized fuel flowing radially outward of the fuel distributor. A combustor located downstream of the centrifugal compressor. A fuel distribution system includes a fuel nozzle having a spray tip located outside of a combustor, the spray tip positioned to inject fuel into the fuel plenum of the fuel distributor on the impeller while the gas turbine engine is operating.

### CROSS-REFERENCE TO RELATED APPLICATIONS

This application claims priority on U.S. Patent Application No. 63/713,858 filed Oct. 30, 2024, the entire content of which is incorporated by reference herein.

### TECHNICAL FIELD

The disclosure relates generally to aircraft engines and, more particularly, to gas turbine engines having a centrifugal compressor.

### BACKGROUND

In most gas turbine engines, compressed air exiting a compressor is directed into a combustion chamber downstream of the compressor, and the compressed air is mixed with fuel that is injected into the combustion chamber and ignited. The fuel is typically injected into the combustion chamber by a plurality of fuel nozzles, which project into the combustion chamber and act to atomize the fuel injected into the combustion chamber. Fuel flow to the fuel nozzles is controlled by a fuel control unit which may be driven by an accessory gearbox of the engine.

### SUMMARY

There is accordingly provided a gas turbine engine, comprising: a centrifugal compressor including an impeller and a diffuser downstream of the impeller, the impeller being fixed to an engine shaft for rotation about a longitudinal axis, a fuel distributor on a rear face of the impeller for rotation therewith, the fuel distributor including a flange defining a fuel plenum on a radially inner side of the flange, fuel apertures extending radially through the flange of the fuel distributor, wherein the flange is structure such that rotation of the impeller while the gas turbine engine is operating forces fuel in the fuel plenum to flow radially outward through the fuel apertures to generate a spray of atomized fuel flowing radially outward of the fuel distributor; a combustor located downstream of the centrifugal compressor and having a combustor inlet communicating with the diffuser and receiving compressed airflow therefrom while the gas turbine engine is operating; and a fuel distribution system including a fuel nozzle having a spray tip located outside of the combustor, the spray tip positioned to inject fuel into the fuel plenum of the fuel distributor on the impeller while the gas turbine engine is operating, and a fuel supply in fluid flow communication with the fuel nozzle.

In certain embodiments, the gas turbine engine as defined above and described herein includes one or more of the following features, in whole or in part, and in any combination.

In certain embodiments, the rear face extends radially away from the longitudinal axis and terminates at a radially outer edge of the impeller located adjacent an impeller outlet, the fuel nozzle being located radially inwardly of the radial outer edge of the impeller.

In certain embodiments, the fuel distributor is located at a radially location on the rear face of the impeller that is radially inward of a radially outer edge of the impeller.

In certain embodiments, the spray of atomized fuel flow radially outward from the flange of the fuel distributor to the radially outer edge of the impeller.

In certain embodiments, the spray of atomized fuel flows radially outward within a combustor passage, the combustor passage having an inlet at a radially inner end proximate the fuel distributor and an outlet at a radially outer end that communicates with the combustor.

In certain embodiments, an annular groove is defined in the rear face of the impeller, the fuel distributor including a radially extending body received within the annular groove with the flange projecting axially outward from the radially extending body.

In certain embodiments, the fuel distributor is removably fastened to the rear face of the impeller.

In certain embodiments, the fuel distributor is spring loaded and biased in a mounting position of the fuel distributor on the impeller.

In certain embodiments, a snap ring is located at a radially inner diameter of the fuel distributor, the snap ring retaining the fuel distributor in place within an annular groove defined in the rear face of the impeller.

In certain embodiments, the flange projects axially away from the rear face of the impeller.

In certain embodiments, the fuel apertures include a plurality of fuel apertures that are circumferentially equally spaced apart about a full circumference of the flange of the fuel distributor.

In certain embodiments, the impeller has impeller vanes extending between leading edges and trailing edges, the leading edges being located at an axially facing impeller inlet and the trailing edges located at an impeller outlet facing radially outward and opening into the diffuser.

There is also provided a fuel distribution system for a gas turbine engine comprising a centrifugal compressor and a combustor downstream of the centrifugal compressor, the fuel distribution system comprising: an impeller of the centrifugal compressor; a fuel distributor disposed on a rear face of the impeller for rotation therewith while the gas turbine engine is operating, the fuel distributor extending circumferentially about the impeller and being located radially inward of a radially outer edge of the impeller, the fuel distributor including a flange projecting away from the rear face and having fuel apertures extending through the flange; a fuel nozzle having a spray tip located outside of the combustor and positioned to direct a fuel flow onto a radially inner surface of the flange of the fuel distributor while the gas turbine engine is operating; a fuel supply in fluid flow communication with the fuel nozzle to provide fuel thereto; and wherein centrifugal force generated by rotation of the impeller while the gas turbine engine is operating causes the fuel to flow radially outward through the fuel apertures in the fuel distributor, thereby generating a radially-directed spray of atomized fuel.

In certain embodiments, the fuel distribution system as defined above and described herein includes one or more of the following features, in whole or in part, and in any combination.

In certain embodiments, the fuel nozzle is located radially inwardly of the radially outer edge of the impeller.

In certain embodiments, the radially inner surface of the flange of the fuel distributor circumscribes a fuel plenum defined radially inward of the flange, the fuel plenum communicating with the fuel apertures.

In certain embodiments, the fuel distributor feeds the radially-directed spray of atomized fuel flows radially outward from the flange of the fuel distributor towards the radially outer edge of the impeller.

In certain embodiments, the radially-directed spray of atomized fuel flows radially outward within a combustor passage, the combustor passage having an inlet at a radially inner end proximate the fuel distributor and an outlet at a radially outer end that communicates with the combustor.

In certain embodiments, an annular groove is defined in the rear face of the impeller, the fuel distributor including a radially extending body received within the annular groove with the flange projecting axially outward from the radially extending body.

In certain embodiments, the fuel distributor is removably fastened to the rear face of the impeller.

There is further provided a method for combusting fuel in a gas turbine engine, comprising: generating compressed airflow using a centrifugal compressor having an impeller and a diffuser downstream of the impeller; directing the compressed airflow into an annular combustor; supplying a flow of fuel to a fuel distributor fixed to the impeller of the centrifugal compressor for rotation therewith; using centrifugal forces to force the fuel through the fuel distributor thereby atomizing the fuel and radially directing atomized fuel into the annular combustor; and combusting a mixture of the compressed airflow and the atomized fuel within the annular combustor.

### BRIEF DESCRIPTION OF THE DRAWINGS

Reference is now made to the accompanying figures in which:

FIG. 1 is a schematic cross-sectional view of a gas turbine engine;

FIG. 2 is a partial cross-sectional view of the centrifugal compressor and combustor of FIG. 2, showing the impeller of the centrifugal compressor and a fuel distributor mounted thereon;

FIG. 3 is a detailed view taken from region 3 in FIG. 2;

FIG. 4 is the cross-sectional view of FIG. 2, showing air flow and fuel flow through the centrifugal compressor and the combustor; and

FIG. 5 is a flow chart of a method of combusting fuel in a gas turbine engine.

### DETAILED DESCRIPTION

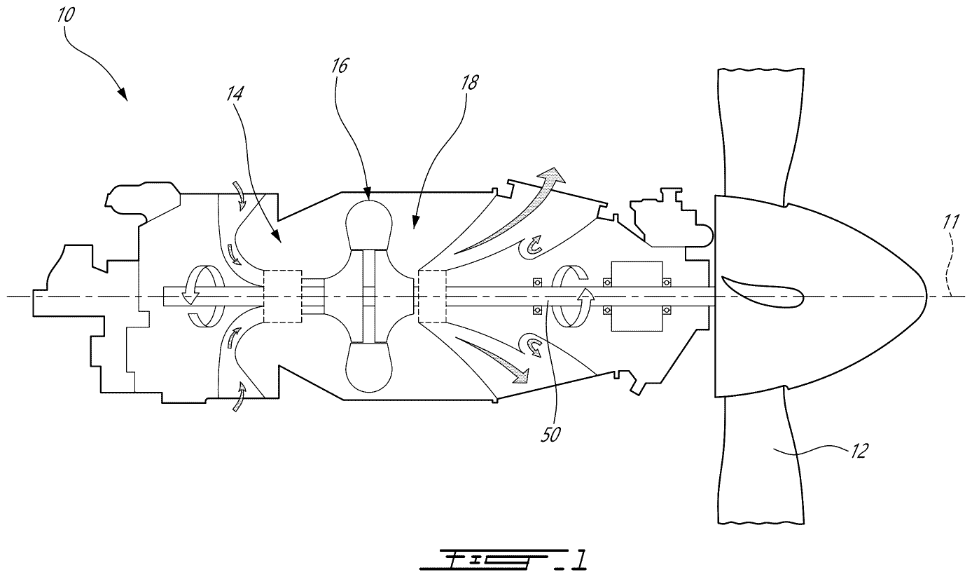

FIG. 1 illustrates a gas turbine engine 10 (or simply “engine” 10) of a type preferably provided for use in subsonic flight, and configured in this embodiment for driving a load 12, such as, but not limited to, a propeller 12 or, alternately, a helicopter rotor or rotorcraft rotor. Depending on the intended use, the engine 10 may be any suitable aircraft engine, and may be configured as a turboprop engine or a turboshaft engine. The gas turbine engine 10 generally comprising in serial flow communication a compressor section 14 for pressurizing air, a combustor section 16 in which the compressed air is mixed with fuel and ignited for generating an annular stream of hot combustion gases, and a turbine section 18 for extracting energy from the combusted gases. Also shown is a central longitudinal axis 11 of the engine 10.

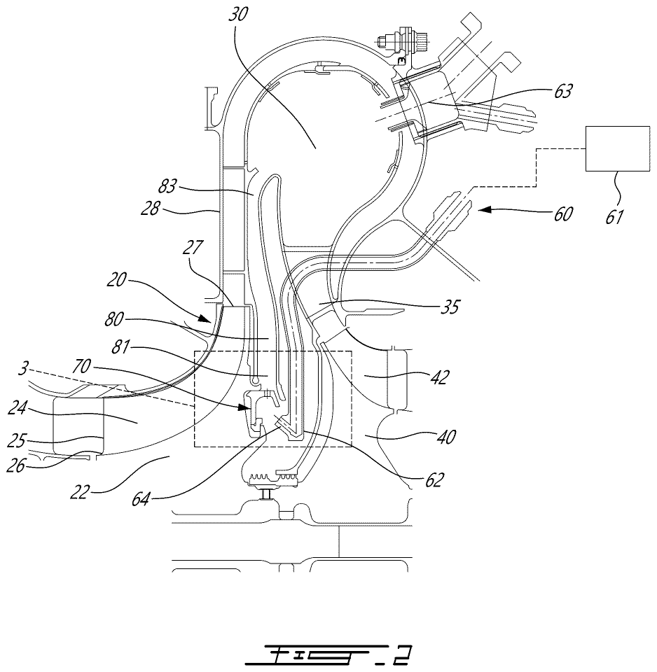

Referring also to FIG. 2, the gas turbine engine 10 includes an annular combustor 30 which forms part of the combustor section 16, a centrifugal compressor 20 which forms part of the compressor section 14, and a radial turbine 40 which forms part of the turbine section 18. Even though the present description and FIG. 1 may specifically refer to a turboprop engine as an example, it is understood that aspects of the present disclosure may be equally applicable to other types of combustion engines in general, and other types of gas turbine engines in particular, including but not limited to turboshaft or turbofan engines, auxiliary power units (APU), and the like.

Referring still to FIG. 2 in more detail, the centrifugal compressor 20 of the compressor section 14 of the gas turbine engine 10 includes an impeller 22 that is fixed to an engine shaft 50 for rotation therewith about the longitudinal axis 11. The impeller 22 has a plurality of impeller vanes 24 extending between leading edges 25 located the impeller inlet and trailing edges 27 located at the impeller outlet, which faces radially outwardly and opens into a diffuser 28 located immediately downstream from the impeller 22. The diffuser 28 is in communication with an inlet of the combustor, such that compressed air flowing out of the diffuser 28 is received into the combustor 30. Accordingly, incoming air flowing substantially axially enters the impeller 22 at its inlet, and is redirected radially such that the accelerated air exiting the impeller is radially directed through the diffuser 28. The diffuser 28 may be a pipe diffuser, a vane diffuser, or another suitable diffuser type. The compressor section 14 may also include other compression stages (either axial compressors or other centrifugal compressors), located further upstream of the centrifugal compressor 20.

The pressure of the air flowing through the diffuser 28 of the centrifugal compressor 20 increases, before the compressed air flow into the annular combustor 30 where the compressed air is mixed with fuel and ignited by an ignitor 63. In a particular embodiment, the ignitor may include one or more torch ignitors for example. After combustion within the combustor 30, the hot gases exit the combustor via the combustor exit duct 35 before flowing into the downstream turbine section 18.

Still referring to FIG. 2, the turbine section 18 includes at least a radial turbine 40 positioned immediately downstream of the combustor 30 and having a plurality of turbine blades 42 which received the hot combustion gases from the combustor exit duct 35 communicating therewith. As discussed above, the turbine blades 42 are driven by the exhaust from the combustor 30 to extract energy, for example mechanical energy to power a rotor blade or electrical energy via a generator (not shown). The radial turbine 40 of the turbine section 18 and the impeller 22 of the centrifugal compressor 20 are arranged back to back, and thus may carry similar but opposing loads. In one embodiment, the impeller 22 and the radial turbine 40 may be structurally joined, such that they rotate together at the same speed as the shaft upon which they are mounted.

Unlike typical gas turbine engine combustors, in the present engine 10 is not fed into the combustor 30 via a plurality of fuel nozzles which inject fuel directly into the combustor 30. Rather, as will now be described in further detail, the engine 10 of the present disclosure employs a fuel distribution system 60 that introduces fuel into the combustor 30 indirectly using the centrifugal compressor 20 (i.e., fuel is not injected directly into the combustor by one or more fuel nozzle spray tips that project into the combustor). This provides a combustor and fuel system that has an axially length that is less than traditional gas turbine engines having fuel nozzles that inject fuel directly into the combustor. Consequently, the present engine 10 is more compact, and has a shorter total axial length, than a corresponding typical turbine engine.

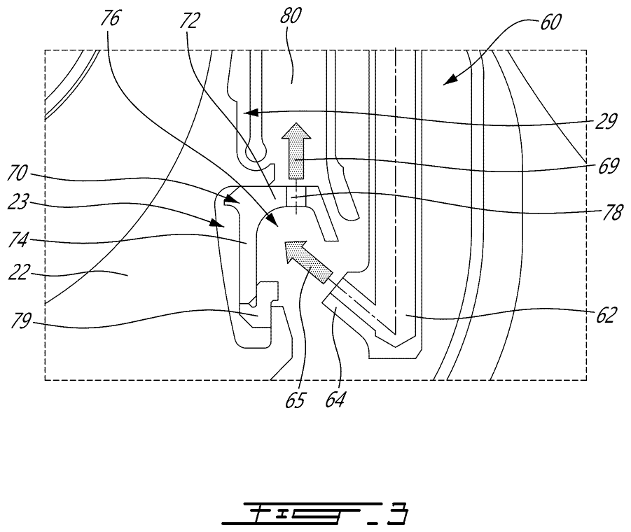

Referring to FIGS. 2 and 3, the fuel distribution system 60 includes at least one fuel nozzle 62 that is located entirely outside of the combustor 30 of the engine, and a fuel supply 61 located within the engine 10 and which provides fuel to the fuel nozzle 62. As see in FIGS. 2 and 3, the fuel nozzle 62 is also located radially inwardly of a radially outer edge of the impeller 22, thereby providing for a very axially compact engine configuration.

The fuel nozzle 62 includes a spray tip 64 that is outside of the combustor 30. Consequently, the spray tip 64 of the fuel nozzle 62 does not inject fuel directly into the combustor 30. Rather, as best seen in FIG. 3, the spray tip 64 of the fuel nozzle 62 injects a fuel jet (or fuel spray) 65 onto a fuel distributor 70 mounted on a rear face 29 of the impeller 22. The fuel distributor 70 is fixed in place on the rear face 29 of the impeller 22, and as such rotates with the impeller. In a particular embodiment, the fuel distributor 70 is formed separately from the remainder of the impeller 22, and is fastened in place thereon. As such, the fuel distributor 70 can be removed and replaced, if or when necessary, such as for service or during engine overhaul for example. In this embodiment, the fuel distributor 70 is thus removably fastened in place on the impeller. As seen in FIG. 3, for example, the fuel distributor 70 is received within an annular groove 23 defined in the rear face 29 of the impeller 22. The annular groove 23 is sized to receive a portion of the fuel distributor (such as a radially extending body 74 thereof, as described in further detail below) and is complimentarily shaped such as to receive the portion of the fuel distributor 70 therein. A snap ring 79, located at the radially inner diameter of the fuel distributor 70, is used to retain the fuel distributor 70 in place within the annular groove 23 in the impeller 22. In one particular embodiment, the fuel distributor 70 is spring loaded and biased in its mounting position within the annular groove 23, such that it can be snapped in place within annular groove 23. The fuel distributor 70 is located a radially location of the rear face 29 of the impeller that is radially inward of the trailing edges 27 of the impeller vanes 24, and thus radially inward of the radially outer edge of the impeller 22. In a particular embodiment, the fuel distributor 70 is located radially outward of a radially inner end 26 of the leading edges 25 of the impeller vanes 24, and therefore may in certain embodiments be substantially radially aligned with the leading edges 25 of the impeller vanes 24, but on the rear face 29 of the impeller 22 that is on the opposite side from the impeller vanes 24.

Referring still to FIG. 3, the fuel distributor 70 includes an axially extending flange 72 (or simply “flange” 72) that projects axially away (rearwardly) from the rear face 29 of the impeller 22, and the body 74 that extends radially and is thus at least partially aligned with and/or parallel to the rear face 29 of the impeller 22. The fuel distributor 70 and its flange 72 are annular and extend circumferentially about the longitudinal axis 11 (see FIG. 1). The fuel distributor 70 also includes a fuel plenum 76 that is defined between the axially extending flange 72 and the radially extending body 74. The fuel plenum is thus only partially enclosed, being upon on a radially inner and/or axially rearward side such as to receive the fuel jet 65 therein that is injected by the spray tip 64 of the fuel nozzle 62. The fuel plenum 76 is thus located on a radially inner side of the flange 72 of the fuel distributor 70. Additionally, as shown in FIG. 3, the fuel distributor 70 includes fuel apertures 78 extending radially through the flange 72. As such, fuel located within the fuel plenum 76 can flow through the fuel apertures 78. More specifically, rotation of the impeller 22 will force fuel within the fuel plenum 76 to flow radially outward through the fuel apertures 78, due the centrifugal force. In a particular embodiment, the fuel apertures 78 include a plurality of fuel apertures that are circumferentially equally spaced apart about the full circumference of the flange 72.

Thus, in the fuel distribution system 60, the spray tip(s) 64 of the fuel nozzle(s) 62 direct a spray or jet of fuel at least partially radially outward (i.e., in a direction having at least a radially outward component, even the flow of fuel also has an axial component) into the fuel plenum 76 of the rotating fuel distributor 70 and/or onto a radially inner surface of the flange 72, and the fuel within the plenum 76 is then forced radially outward through the fuel apertures 78 in the flange 72 of the fuel distributor 70. The fuel exiting the fuel apertures 78 will atomize when mixed with the compressed air that flows within a combustor passage 80 that communicates with the annular combustor 30, thereby forming an atomized fuel spray 69 with this combustor passage 80 that feeds into the annular combustor 30. As seen in FIG. 2, the combustor passage 80 is located axially rearward of the impeller 22, and has an inlet 81 located at a radially inner end and an outlet 83 at a radially outer end thereof. The outlet 83 at the radially outer end of the combustor passage 80 communicates with and feeds into the annular combustor 30.

Accordingly, rotation of the impeller 22 causes fuel within the fuel plenum 76 of the fuel distributor 70 to flow radially outward through the fuel apertures 78, thereby generating the radially-directed spray 69 of atomized fuel which ultimately flows downstream into the annular combustor 30 via the combustor passage 80.

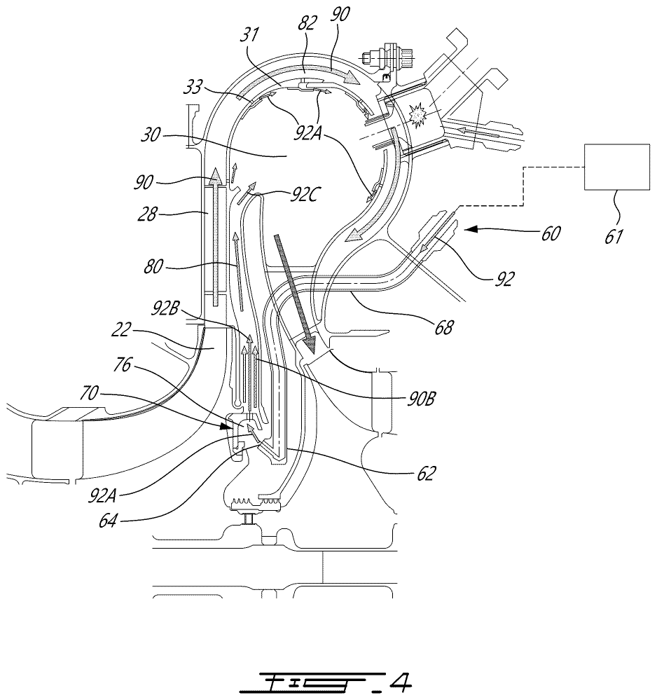

Referring to FIG. 4, the flow of air and fuel in the engine 10 is depicted. The airflow 90 passes through the diffuser 28, after exiting the impeller 22, and flows within the air plenum 82 surrounding the inner liner 31 of the combustor 30. The compressed airflow 90 within the air plenum 82 enters into the combustor 30, as shown at 90A, via airflow passages 33 in the inner liner 31 of the combustor. Turning now to the fuel flow in the fuel distribution system 60, and as described above, fuel flow 92 is fed from the fuel source 61, through one or more fuel conduits 68, to the one or more fuel nozzles 62. The spray tips 64 of the fuel nozzles 62 generate a spray 92A of the fuel flow 92, outside of the combustor 30, that is directed into the fuel plenum 76 of the fuel distributor 70 on the rotating impeller 22. The fuel located within the fuel plenum 76 is forced through the fuel apertures 78 defined in the fuel distributor 70 by centrifugal force and is distributed directed radially outward at 92B, where the fuel mixes with compressed air 90B within the combustor passage 80 and atomizes. The atomized fuel 92C then flows into the combustor 30 at the outlet 83 located at the radially outer end of the combustor passage 80.

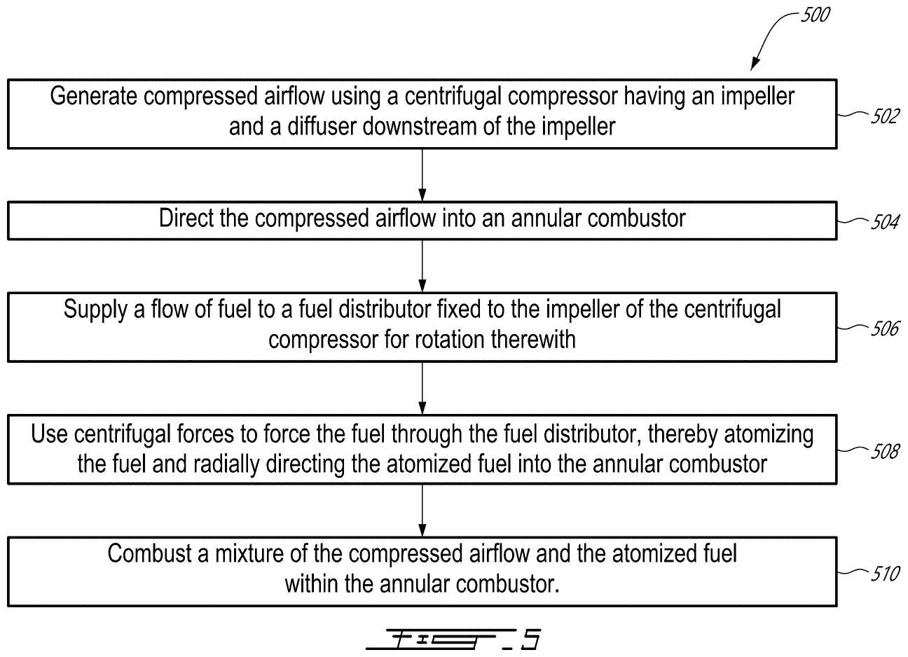

Referring now to FIG. 5, a method 500 of combusting fuel in a gas turbine engine, such as the gas turbine engine 10 described above, will now be described. At step 502, compressed airflow is generated using a centrifugal compressor 20, having an impeller 22 and a diffuser 28 downstream of the impeller. At step 504, the compressed airflow generated by the centrifugal compressor 20 is directed into the annular combustor 30. At step 506, a flow of fuel is supplied to a fuel distributor 70 that is fixed to the impeller 22 of the centrifugal compressor 20 for rotation with the impeller. At step 508, the method includes using centrifugal forces to force the fuel through the fuel distributor on the impeller, thereby atomizing the fuel and radially directing the atomized fuel into the combustor 30. At step 510, a mixture of the compressed airflow, provided by the centrifugal compressor 20, and the atomized fuel, fed into the annular combustor by the fuel distributor 70 on the impeller 22, is combusted within the combustor 30.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The terms “connected”, “mounted” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A gas turbine engine, comprising:
a centrifugal compressor including an impeller and a diffuser downstream of the impeller, the impeller being fixed to an engine shaft for rotation about a longitudinal axis, a fuel distributor on a rear face of the impeller for rotation therewith, the fuel distributor including a flange defining a fuel plenum on a radially inner side of the flange, fuel apertures extending radially through the flange of the fuel distributor, wherein the flange is structure such that rotation of the impeller while the gas turbine engine is operating forces fuel in the fuel plenum to flow radially outward through the fuel apertures to generate a spray of atomized fuel flowing radially outward of the fuel distributor;
a combustor located downstream of the centrifugal compressor and having a combustor inlet communicating with the diffuser and receiving compressed airflow therefrom while the gas turbine engine is operating; and
a fuel distribution system including a fuel nozzle having a spray tip located outside of the combustor, the spray tip positioned to inject fuel into the fuel plenum of the fuel distributor on the impeller while the gas turbine engine is operating, and a fuel supply in fluid flow communication with the fuel nozzle.

2. The gas turbine engine as defined in claim 1, wherein the rear face extends radially away from the longitudinal axis and terminates at a radially outer edge of the impeller located adjacent an impeller outlet, the fuel nozzle being located radially inwardly of the radial outer edge of the impeller.

3. The gas turbine engine as defined in claim 1, wherein fuel distributor is located at a radially location on the rear face of the impeller that is radially inward of a radially outer edge of the impeller.

4. The gas turbine engine as defined in claim 3, wherein the spray of atomized fuel flow radially outward from the flange of the fuel distributor to the radially outer edge of the impeller.

5. The gas turbine engine as defined in claim 1, wherein the spray of atomized fuel flows radially outward within a combustor passage, the combustor passage having an inlet at a radially inner end proximate the fuel distributor and an outlet at a radially outer end that communicates with the combustor.

6. The gas turbine engine as defined in claim 1, wherein an annular groove is defined in the rear face of the impeller, the fuel distributor including a radially extending body received within the annular groove with the flange projecting axially outward from the radially extending body.

7. The gas turbine engine as defined in claim 1, wherein the fuel distributor is removably fastened to the rear face of the impeller.

8. The gas turbine engine as defined in claim 6, wherein the fuel distributor is spring loaded and biased in a mounting position of the fuel distributor on the impeller.

9. The gas turbine engine as defined in claim 6, wherein a snap ring is located at a radially inner diameter of the fuel distributor, the snap ring retaining the fuel distributor in place within an annular groove defined in the rear face of the impeller.

10. The gas turbine engine as defined in claim 1, wherein the flange projects axially away from the rear face of the impeller.

11. The gas turbine engine as defined in claim 1, wherein the fuel apertures include a plurality of fuel apertures that are circumferentially equally spaced apart about a full circumference of the flange of the fuel distributor.

12. The gas turbine engine as defined in claim 1, wherein the impeller has impeller vanes extending between leading edges and trailing edges, the leading edges being located at an axially facing impeller inlet and the trailing edges located at an impeller outlet facing radially outward and opening into the diffuser.

13. A fuel distribution system for a gas turbine engine comprising a centrifugal compressor and a combustor downstream of the centrifugal compressor, the fuel distribution system comprising:
an impeller of the centrifugal compressor;
a fuel distributor disposed on a rear face of the impeller for rotation therewith while the gas turbine engine is operating, the fuel distributor extending circumferentially about the impeller and being located radially inward of a radially outer edge of the impeller, the fuel distributor including a flange projecting away from the rear face and having fuel apertures extending through the flange;
a fuel nozzle having a spray tip located outside of the combustor and positioned to direct a fuel flow onto a radially inner surface of the flange of the fuel distributor while the gas turbine engine is operating;
a fuel supply in fluid flow communication with the fuel nozzle to provide fuel thereto; and
wherein centrifugal force generated by rotation of the impeller while the gas turbine engine is operating causes the fuel to flow radially outward through the fuel apertures in the fuel distributor, thereby generating a radially-directed spray of atomized fuel.

14. The fuel distribution system as defined in claim 13, wherein the fuel nozzle is located radially inwardly of the radially outer edge of the impeller.

15. The fuel distribution system as defined in claim 13, wherein the radially inner surface of the flange of the fuel distributor circumscribes a fuel plenum defined radially inward of the flange, the fuel plenum communicating with the fuel apertures.

16. The fuel distribution system as defined in claim 13, wherein the fuel distributor feeds the radially-directed spray of atomized fuel flows radially outward from the flange of the fuel distributor towards the radially outer edge of the impeller.

17. The fuel distribution system as defined in claim 16, wherein the radially-directed spray of atomized fuel flows radially outward within a combustor passage, the combustor passage having an inlet at a radially inner end proximate the fuel distributor and an outlet at a radially outer end that communicates with the combustor.

18. The fuel distribution system as defined in claim 13, wherein an annular groove is defined in the rear face of the impeller, the fuel distributor including a radially extending body received within the annular groove with the flange projecting axially outward from the radially extending body.

19. The fuel distribution system as defined in claim 13, wherein the fuel distributor is removably fastened to the rear face of the impeller.

20. A method for combusting fuel in a gas turbine engine, comprising:
generating compressed airflow using a centrifugal compressor having an impeller and a diffuser downstream of the impeller;
directing the compressed airflow into an annular combustor;
supplying a flow of fuel to a fuel distributor fixed to the impeller of the centrifugal compressor for rotation therewith;
using centrifugal forces to force the fuel through the fuel distributor thereby atomizing the fuel and radially directing atomized fuel into the annular combustor; and
combusting a mixture of the compressed airflow and the atomized fuel within the annular combustor.
